(19) United States
(12) Patent Application Publication
(10) Pub. No.: US 2013/0215268 A1
(43) Pub. Date: Aug. 22, 2013

(54) Unknown

(71) Applicant: THALES, (US)

(72) Inventors: Christian NOUVEL, Merignac (FR); Jean-Noel PERBET, Eysines (FR)

(73) Assignee: THALES, Neuilly-sur-Seine (FR)

(21) Appl. No.: 13/769,128

(22) Filed: Feb. 15, 2013

(30) Foreign Application Priority Data
Feb. 16, 2012 (FR) 12 00444

(51) Int. Cl. H04N 7/18

(52) U.S. Cl. CPC H04N 7/183
USPC 348/144

(57) ABSTRACT

A system for rescue of a target by aircraft, comprises control means to plot at least one contour delimiting an area of interest, computation means identifying, on at least one camera, at least one area of interest, in which a predetermined object is likely to be located, an expert system assigning a likelihood coefficient to one identified area of interest, computation means assigning a likelihood coefficient to at least one plotted area of interest, and computation means determining at least one relevant area of interest from the positions and likelihood coefficients assigned to areas of interest comprising at least one identified area of interest in which said object is likely to be located and/or at least one plotted area of interest on a set of images comprising at least one pilot image and/or at least one output image, said display means presenting at least one first relevant area of interest.

### FIELD OF THE INVENTION

The field of the invention is that of aircraft rescue missions, notably by helicopter in isolated places.

This kind of mission consists, for example, in leaving very quickly on receiving an alert to go to identify injured parties in difficult and/or extreme conditions: in mountains, in winter conditions (snow, avalanches, etc.) or in summer; at sea, to go and pick up shipwreck victims.

The issue for the crew in this kind of mission is to go as quickly as possible to the accident sites in flight visibility conditions that are often degraded (difficult weather conditions, twilight), to find the individual(s) being sought while having very imprecise knowledge as to the exact location of the accident, possibly to set down nearby in difficult places (for example on snow, ice, etc.) or to carry out a helihoisting procedure and to return as quickly as possible to a hospital with the individual(s) sought before nightfall (night flying prohibited).

### BACKGROUND OF THE INVENTION

Currently, the helicopters used for these missions are powerful helicopters but the crew is always reduced to working in a “rustic” manner: to identify an injured party or a small craft, the crew works essentially with sight and conventional binoculars, sometimes with night-vision binoculars and/or an infrared camera and/or a radar. To pilot close to the ground and set down, the crew has to have wide experience of the geographic situations to have a feeling for the local wind, to estimate the quality of the ground, to appreciate the relief (which is for example very difficult in a plain environment such as snow . . . ).

However, since the visibility conditions are degraded in terms of visibility and the crew is subject to turbulent movements, it is difficult to locate a target and locate an area to set down based only on a direct vision or with the aid of binoculars.

Moreover, the in-flight storage means are essentially the human brain. In these conditions, it is possible to pass by an injured party, miss markers through worsening visibility conditions and lack precision to return to this area.

### SUMMARY OF THE INVENTION

The aim of the present invention is to propose a helicopter rescue aid system to aid the crew in locating a target (person, group, vehicle) to be rescued.

Another aim of the invention is to propose a helicopter rescue aid system to aid the crew in locating a landing area on which the helicopter can set down.

To this end, the subject of the invention is a system for aiding in the rescue of a target by aircraft, comprising, installed in the aircraft:

at least one camera capable of supplying images, called output images of said camera, of a scene of the environment of the aircraft,

a display module making it possible to present, to the crew, images, called pilot images, corresponding to output images of said at least one camera which have undergone modifications enabling the crew to view them correctly, on at least one screen,

a control module enabling the crew to plot at least one contour delimiting an area of interest, called plotted area of interest, on the pilot images which are presented to it,

a first computation module configured to identify, on output images of said at least one camera, at least one area of interest, called identified area of interest, in which a predetermined object is likely to be located,

an expert system making it possible to assign a likelihood coefficient to said at least one identified area of interest,

a second computation module configured to assign a likelihood coefficient to said at least one plotted area of interest, and

a third computation module making it possible to identify a set of relevant areas of interest from a set of areas of interest comprising each identified area of interest and each plotted area of interest on a set of images,

the third computation module being configured in such a way as to identify a set of relevant areas of interest from the positions and likelihood coefficients of each identified area of interest and of each plotted area of interest on said set of images when the set of areas of interest comprises more than one area of interest,

the third computation module also being configured in such a way that:
when the set of areas of interest does not comprise any area of interest, no relevant area of interest is identified, and
when the set of areas of interest comprises a single area of interest, a single relevant area of interest, corresponding to said area of interest, is identified,

the display module being configured in such a way as to present to the crew said at least one relevant area of interest, when it exists, on at least one screen.

Advantageously, the expert system is configured in such a way as to use basic knowledge comprising knowledge concerning the geographic environment of the aircraft, concerning the meteorological conditions, concerning said object, concerning the technical characteristics of said at least one camera, concerning characteristics of the aircraft, to deduce therefrom, by the use of rules, values of facts relating to the characteristics of the object on the output images of said at least one camera and on the quality of the images obtained from said at least one camera.

Advantageously, the expert system is capable of triggering actions to improve the quality of the images on which the first computation means identify the identified areas of interest, the expert system being capable of taking account thereof in the context of the execution of rules to assign values to facts.

Advantageously, the expert system is capable of triggering the switching on and/or the switching off of at least one spotlight capable of emitting a visible light and possibly an ultraviolet light, in the field of view of said at least one camera and/or of determining at least one method for preprocessing the output images of said at least one camera and of triggering the execution of said at least one method by the computation module.

Advantageously, the expert system is capable of determining at least one processing method for identifying identified areas of interest on the output images of said at least one camera and of triggering the execution of said at least one method by the computation module.

Advantageously, the first computation module is configured to identify an identified area of interest in which an object corresponding to a target to be rescued is likely to be located.

Advantageously, the first computation module is configured to identify an identified area of interest in which an object corresponding to an aircraft landing area is likely to be located.

Advantageously, the characteristics of the landing area comprise a condition concerning its dimensions, a condition concerning its slope and a condition concerning the hardness of the ground.

Advantageously, the system comprises a monitoring device making it possible to deliver, in real time to the expert system, knowledge concerning the current status of the aircraft and a meteorological module making it possible to deliver, in real time to the expert system, knowledge concerning the meteorological conditions.

Advantageously, the display module is configured to present to the crew each identified area of interest.

Advantageously, the representations of the areas of interest are polygons delimiting said areas of interest.

Advantageously, the control module enables the crew to select expert images and copy them into a display area dedicated to the display of the pilot images.

Advantageously, the likelihood coefficient assigned to the plotted areas of interest is equal to 0.5.

Advantageously, the control module enables the crew to select the set of images.

Advantageously, when the set of areas of interest comprises a number of areas of interest, the third computation module determines said at least one relevant area of interest by assigning, to the areas of interest of said set, a correlation coefficient, the correlation coefficient assigned to an area of interest being a function of said likelihood coefficient assigned to the area of interest concerned and of a distance separating the area of interest concerned from the other areas of interest of the set of areas of interest.

Advantageously, the third computation module is configured to determine, when there is at least one plotted or identified area of interest in the set of images, a single relevant area of interest corresponding to the area of interest that has the highest correlation coefficient.

Advantageously, the relevant areas of interest correspond to the areas of interest that have a correlation coefficient greater than a predetermined threshold.

Advantageously, when the third computation module determines a number of relevant areas of interest, the display module gives different representations of the relevant areas of interest which have different correlation coefficients.

Advantageously, the system comprises at least one camera sensitive in the visible domain and outside the visible domain and/or at least one camera sensitive in the visible domain and one camera sensitive outside the visible domain.

Advantageously, the system comprises three cameras operating respectively in ultra-violet radiation, visible radiation and infrared radiation.

### BRIEF DESCRIPTION OF THE FIGURES

Other features and advantages of the invention will become apparent on reading the following detailed description, given as a non limiting example and with reference to the appended drawings in which:

FIG. 1 schematically represents an embodiment of the system according to the invention,

FIG. 2 schematically represents, in plan view, a way of installing elements of the system of FIG. 1 on a helicopter (the rotor of the helicopter not being represented for greater clarity),

FIG. 3 schematically represents a way of presenting images and areas of interest to the pilot on the pilot screen,

FIG. 4 schematically represents the main steps of a method implemented by the system according to the invention,

FIG. 5 schematically represents, on one and the same image reference frame, a set of areas of interest.

From one figure to another, the same elements are identified by the same references.

### DETAILED DESCRIPTION OF THE INVENTION

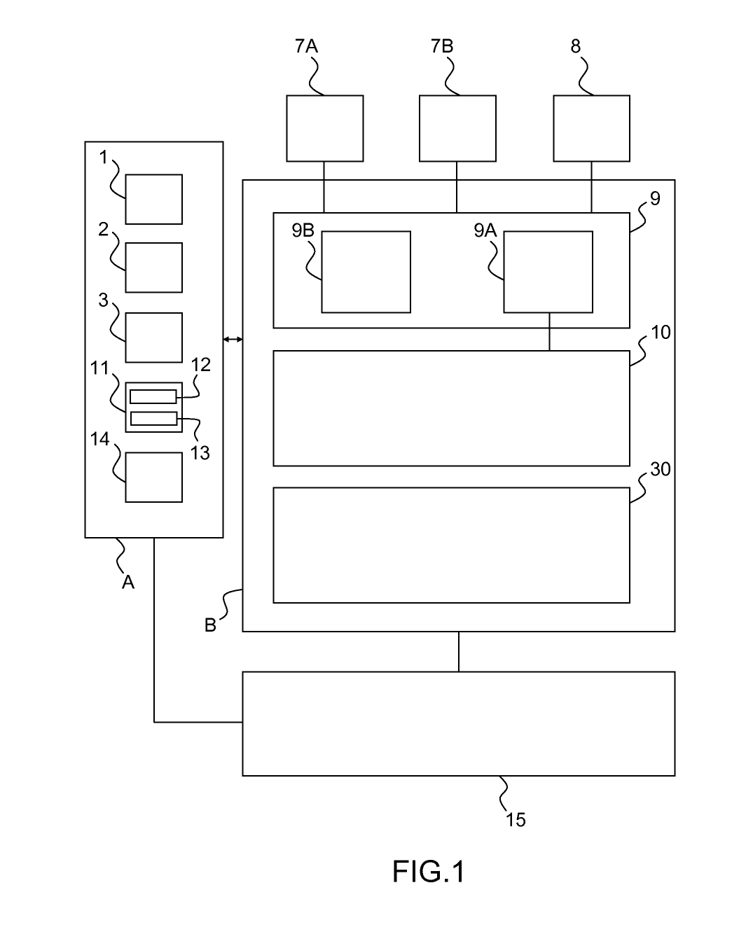

FIG. 1 schematically represents the various elements of the aircraft rescue aid system according to the invention. In the embodiment of the figures, the aircraft is a helicopter H.

The system according to the invention comprises a set of capture means A capable of delivering information in real time to a set of computation modules B which are, for example, computers.

The capture means A comprise a set of cameras sensitive in different spectral bands. In the example represented in FIG. 1, the system comprises a camera sensitive in visible light 1, an infrared camera 2 and a camera sensitive in the ultraviolet domain 3.

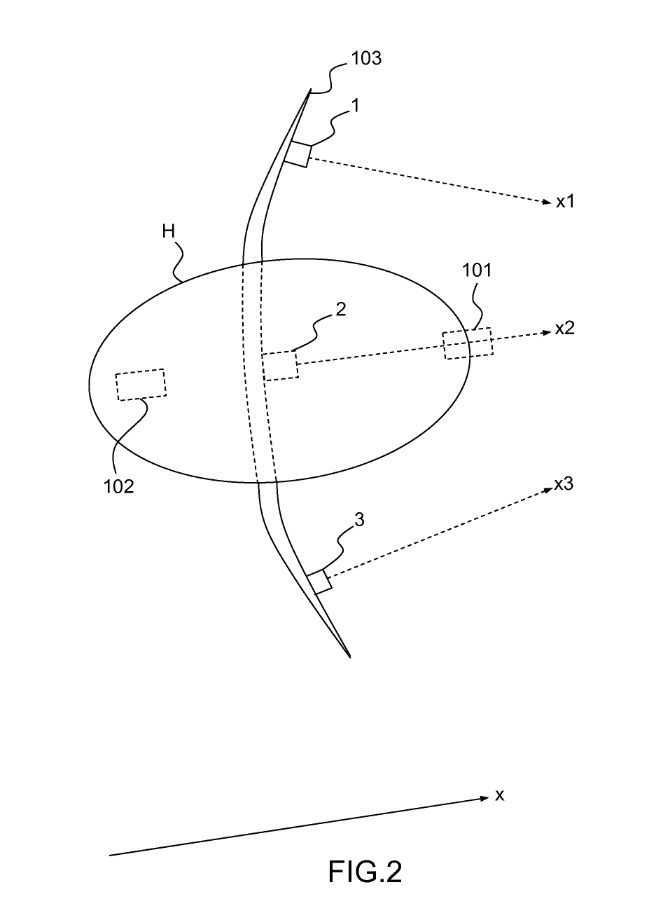

As can be seen in FIG. 2, the cameras 1, 2, 3 are arranged, on the helicopter H, in such a way as to capture images of one and the same scene of the environment of the aircraft situated in the field of view of the crew. These three cameras deliver real-time digital images to the computation modules B.

The cameras 1, 2, 3 are oriented forward and downward from the helicopter H so as to capture images of a scene situated in the field of view of the crew. The axis x is an axis extending longitudinally from the rear to the front of the helicopter.

The respective cameras 1, 2, 3 are oriented on respective optical axes x1, x2, x3 that are coplanar but not parallel. However, the cameras are arranged in such a way that their respective fields of view intersect and that the scene to be viewed is located in the area where the fields of view intersect. The fact that the optical centers are not parallel makes it possible to prioritize the detection of objects from images obtained from three cameras rather than the precise identification of the positions of these objects.

As can be seen in FIG. 2, these cameras 1, 2, 3 are installed on the helicopter H. They are spaced apart on a support 103 having a concave form, preferably elliptical or parabolic, oriented towards the front of the helicopter so that their respective optical centers are arranged on an elliptical or parabolic curve. The parabolic or elliptical form of the support used makes it possible to simplify certain types of computation performed in real time to compare the images supplied (superposition of the images in a single image reference frame).

The system according to the invention advantageously comprises at least one spotlight arranged in such a way as to illuminate the scene captured by the cameras.

In the example represented in FIG. 2, the system according to the invention comprises a conventional spotlight 101 emitting white visible light. This type of spotlight is conventionally used in landing phases.

In the embodiment of FIG. 2, the system also comprises an additional spotlight 102 simultaneously emitting in visible light and in ultraviolet.

The system comprises a control module 8 which will be described later. Advantageously, the control module 8 comprises means enabling the crew to switch on and switch off the spotlights and/or the expert system which will be described later. This expert system is also capable of controlling the switching-on and the switching-off of these spotlights.

The spotlights 101, 102 make it possible to improve the quality of the images obtained from visible and ultraviolet cameras (energy received by the cameras and contrasts enhanced) when the luminosity is low and therefore more easily identify the target as well as the landing area.

The system also comprises a monitoring device 11 making it possible to deliver real-time information on the current status of the helicopter. This device comprises at least one position module 12 making it possible to determine the position of the aircraft which delivers aircraft position measurements. These modules 12 comprise, for example, systems making it possible to deliver measurements of the latitude and of the longitude such as, for example, a GPS positioning system (GPS standing for “Global Positioning System”), wireless means, one or more inertial units, a flight management system FMS. These modules 12 can also comprise at least one altitude sensor which delivers information on the current altitude of the helicopter such as, for example, an altimeter, an inertial unit. This module 12 may also comprise one or more height sensors capable of delivering information on the current flying height over the terrain. The height sensors are, for example, active systems of radiosonde type and/or systems which compute the height as a function of the current position of the helicopter and of the content of an onboard terrain database.

The device 11 also comprises an attitude module 13 making it possible to determine the attitude of the helicopter, capable of delivering information on the roll, trim and yaw angles of the helicopter. This attitude module may comprise standard gyroscopic systems of artificial horizon, turn indicator, direction indicator type present in light helicopters and/or systems of inertial unit type on more sophisticated helicopters.

The system also comprises a meteorological module 14 making it possible to deliver, in real time, information on the meteorological conditions. These meteorological data can make it possible to assess the flight, landing and visibility conditions. They have an influence on the quality of the images output from the cameras called output images of the cameras hereinafter in the text. These meteorological data comprise, for example, information on the atmospheric pressure and/or on the temperature of the atmosphere and/or on an air humidity level and/or on the position of the sun and/or on turbulence and/or on visibility and/or on the force and/or the direction of the wind and/or on the climatic conditions (snow, fog, rain, frost). The module 14 may comprise meteorological sensors capable of taking measurements of quantities representative of the meteorology such as, for example, standard probes (digital thermometers), equipment of altimeter type (static pressure), air data computers. This module may also comprise radio and/or satellite links which are not represented, capable of supplying the helicopter with meteorological information. Such information may also comprise information on the swell, the tide.

The system according to the invention also comprises a control module 8. This control module 8 advantageously comprises means enabling the crew to input meteorological information.

The system according to the invention also comprises a storage module 15 capable of storing information which will be described later. This storage module can be used in real time in read or in write mode by the computation means B which will be described later.

The storage module 15 can be fed with data before the flight or during the flight, by the crew by means of the control module 8. Lists from which the crew can select parameters are advantageously displayed on a screen by means of the graphics module 9B in order for the crew to make selections by means of the control means.

The storage module 15 can also be fed by the capture means A. They can also be fed by means of USB keys or secure memory cards.

The system according to the invention also comprises a computer 9 as well as an expert system 10 installed onboard the aircraft. The computer 9 comprises a graphics module 9B as well as a computation module 9A.

The computation module 9A is capable of receiving real-time information from the set of capture means A. It is capable of implementing image processing methods to detect a target and estimate the size of an object on an image output by a camera.

The expert system 10 is capable of putting questions to the computation module 9A, triggering actions, and receiving responses from this computation mode 9A.

The graphics module 9B is capable of displaying 2D and/or 3D synthetic images as well as images from the three cameras 1, 2, 3 (which are previously read by means of the computation module 9A) on screens 7A, 7B which can be seen by the crew.

A first screen 7A is the screen of the pilot. A second screen 7B is the screen of the co-pilot 7B. These screens are driven by the graphics module 9B of the computer 9. These screens are advantageously of colour multi-function display (MFD) type, provided with their own local on/off control as well as brightness and contrast controls. The technology is standard (tubes, LCD, back projection, etc.).

In an exemplary embodiment, this control module comprises a certain number of buttons with two states (depressed/released) that make it possible to activate or deactivate a set of functions and, for example, potentiometers that make it possible to make fine adjustments to the brightnesses and contrasts of the images.

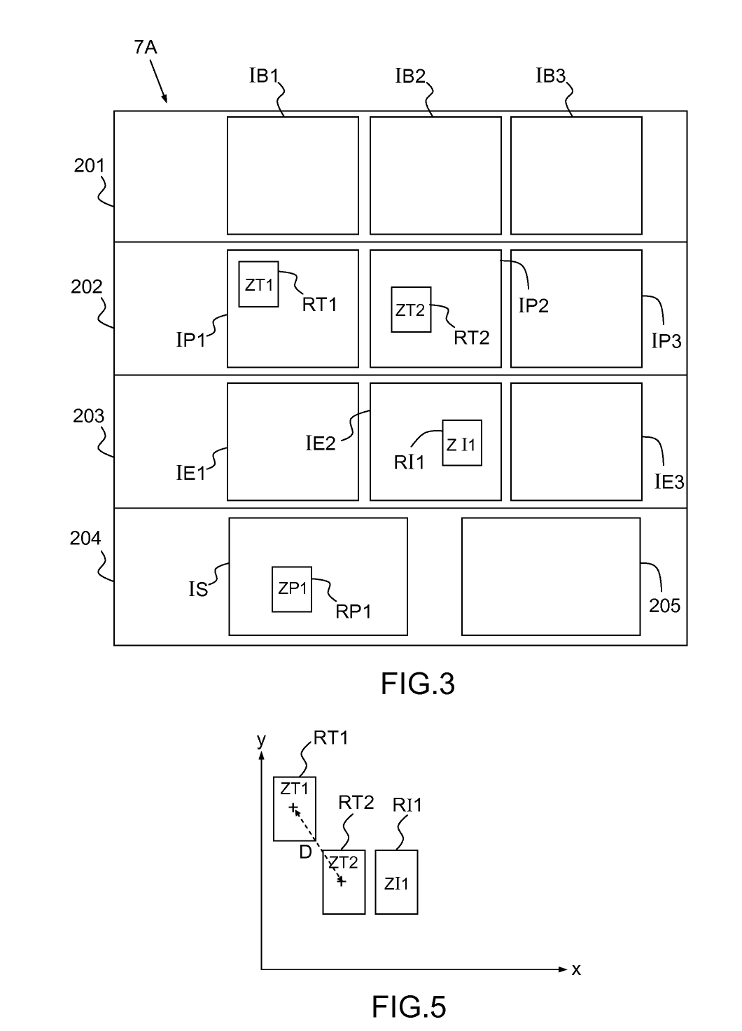

There now follows a more precise description of the operation of the rescue aid system according to the invention with reference to FIG. 3.

The cameras 1, 2, 3 capture images of a scene of the environment of the helicopter situated in the field of view of the crew.

A display module comprising the graphics module 9B is capable of presenting to the pilot pilot images IP1, IP2, IP3, which are obtained from the respective cameras 1, 2, 3 on at least one display screen. Here, the display module is capable of presenting pilot images obtained from the cameras 1, 2, 3 on the pilot 7A and co-pilot 7B screens.

FIG. 3 shows the pilot screen 7A on which the display module simultaneously displays a certain number of information items. Advantageously, identical information items are displayed on the co-pilot screen. As a variant, this information is displayed on a single screen.

The pilot screen 7A is broken down, in this non-limiting example, into four display areas 201, 202, 203, 204. Each of these areas extends over the entire width of the screen.

A first display area 201, which is here a top area, situated in the top part of the screen 7A, on which the display module can present to the pilot first IB1, second IB2 and third IB3 raw images which are output images of the three respective cameras 1, 2, 3. In other words, the raw images or output images of the cameras are the images supplied by the cameras, that is to say the images obtained at the output of the cameras. They have not undergone any modification. These images are displayed side by side in the top area 201.

A calibration chart may be displayed on these screens but is not represented here.

The display module is capable of presenting to the pilot, on a working display area 202 dedicated to the display of pilot images, extending under the first display area 201, first IP1, second IP2 and third IP3 pilot images obtained from the output images of the three respective cameras 1, 2, 3. These three images are displayed side by side in the working display area 202.

The pilot images IP1, IP2, IP3 are not the raw output images of the cameras 1, 2, 3. They have advantageously undergone modifications enabling the crew to interpret them more easily. In other words, these are raw images transformed to favour their legibility by the crew. These modifications are advantageously performed by the graphics module 9B. They comprise, for example, colorimetric transformations of the images which make it possible to present these images in such a way as to be more easily interpretable by the crew, such as, for example, changes to pseudo-colours (red, blue, green) and/or changes of brightness and/or contrast level.

The control module 8 comprises means that advantageously enable the crew to trigger modifications of the pilot images IP1, IP2, IP3.

In the system according to the invention, the control module 8 comprises means enabling the crew (pilot and/or co-pilot) to plot, on the pilot images IP1, IP2, IP3, contours, for example in the form of polygons, delimiting first areas of interest ZT1, ZT2, called plotted areas of interest. Advantageously, in FIG. 3, these polygons are rectangles of index i denoted RTi (RT1, RT2). The contours are superimposed on the images on which they are plotted.

Advantageously, the plotted areas of interest ZT1, ZT2 are presented differently to the pilot according to the cameras from which the pilot images on which they are plotted originate.

For example, the colour of the contours is specific to the cameras from which the pilot images on which they are plotted are obtained. For example, a polygon plotted on an image obtained from the infrared camera is plotted in red, a polygon plotted on an image obtained from the ultraviolet camera is plotted in blue and a polygon plotted on an image obtained from the visible camera is plotted in a different colour, for example green.

The control module 8 advantageously comprises means making it possible to delete and/or translate areas of interest (that is to say, translationally move the polygons delimiting the areas of interest) and/or modify the dimensions of the areas of interest such as, for example, the height and/or the width of an area of interest plotted on a pilot image (that is to say, modify the width and/or the height of the polygons delimiting the areas of interest).

The computation module 9A of the computer 9 associates attributes with each plotted area of interest comprising a unique number, a two-dimensional and/or three-dimensional position, the dimensions of the contour, the camera from which the image on which it has been plotted is obtained. These attributes are stored in the storage module 15.

The display module 9B can present to the pilot, on a display area called expert display area 203 dedicated to the display of expert images, first, second and third expert images IE1, IE2, IE3 which are images obtained from the output images of the three respective cameras 1, 2, 3. This expert display area 203 extends under the working display area 102. The display means are capable of presenting therein to the pilot. In the example represented, these images are displayed side-by-side. The display module is also configured in such a way as to present to the pilot identified areas of interest, here just one ZI1. These areas of interest are represented by contours that can be polygons, and which here is a rectangle denoted RI1. These contours are superimposed on the expert images IE1, IE2 obtained from the output images of the cameras on which the areas of interest that they delimit have been respectively identified.

Advantageously, the identified areas of interest are presented differently to the pilot depending on the cameras from which the images on which they have been identified are obtained. For example, the color of the polygons is specific to the cameras from which the expert images on which they are superimposed are obtained.

The expert images IE1, IE2, IE3 are advantageously images obtained from cameras which have undergone modifications enabling the crew to view them correctly. In other words, they are raw images transformed to favour their legibility by the crew.

The control module 8 advantageously enables the crew to select expert images IE1, IE2, IE3 and/or output images of the cameras, and copy them into the pilot area 202 as pilot image. This enables the crew to delimit areas of interest on the expert or output images when the latter seem to them to be of better quality than the pilot images IP1, IP2, IP3.

The first screen also comprises a fourth area, called synthesis area 204. This synthesis area 204 extends under the expert display area 203. The presentation means are configured to present therein, to the pilot, a synthesis image IS and present therein areas of interest called relevant areas of interest that we will describe later in the text. Here, a relevant area of interest is identified ZP1 and delimited by a rectangle RP1 superimposed on the synthesis image IS.

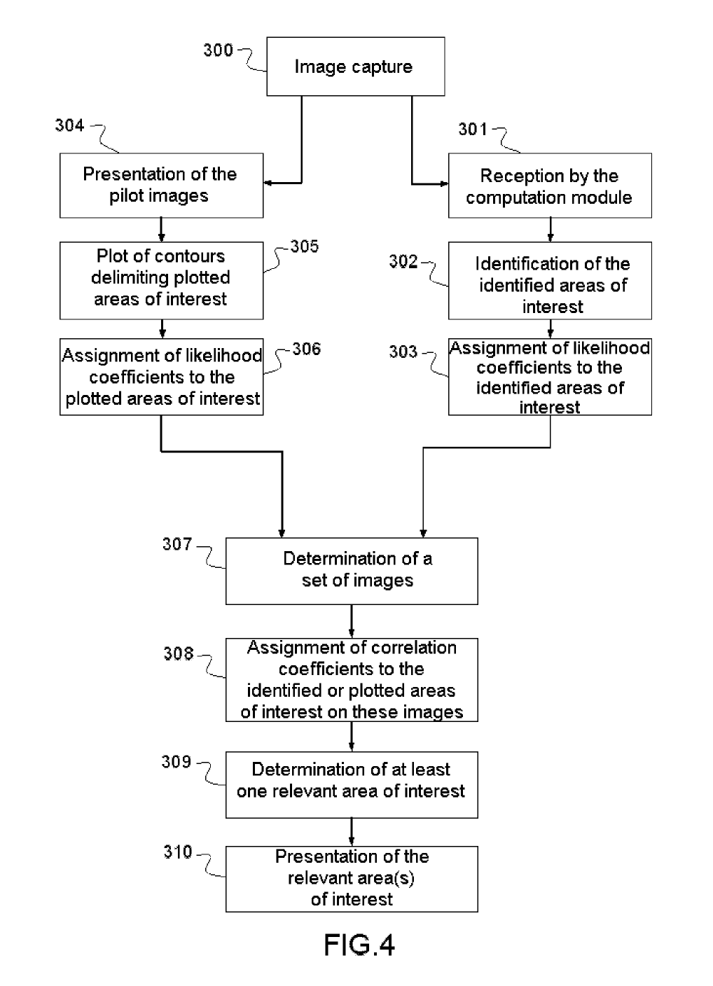

We will now describe how the identified areas of interest ZIi are identified, with i=1 to n and n=1 in FIG. 3. The main steps implemented by the system are represented in FIG. 4.

We have seen that the cameras 1, 2, 3 capture 300 images of the environment of the aircraft.

A first computation module, here the computation module 9A of the first computer 9, receives 301 output images of the cameras 1, 2, 3 and identify 302, on these images, in real time, first identified areas of interest ZI1, in which a predetermined object, which can be the target or a landing area, is likely to be located.

This identification is made by implementing image processing methods that are conventional to the person skilled in the art for identifying, on an image, an area of interest in which a predetermined object is likely to be located. The computation module 9A advantageously performs this detection on the basis of an estimation of the movement of the aircraft and of information on the object being sought, notably on the size of the object sought.

The expert system 10 assigns 303 likelihood coefficients to each of the areas identified by the computation module 9A.

The expert systems are known to the person skilled in the art. They use techniques based on first order predicate logic. They use a facts and rules base and an inference engine, to assist in the decision. The facts and the rules describe a specific working world (here, rescue missions for helicopters). They evolve as the types of missions covered by the system evolve, through errors made and the acquisition of new knowledge. This evolution takes place through updates to the facts and rules bases in the storage module 15.

The facts are entity/value doublets. At the start of the mission, the facts are a list of entities without values. The expert system assigns values to facts, that is to say to entities, during the mission by means of an inference engine using rules.

For this, it uses basic items of knowledge which are values of certain facts. It assigns values to these facts and executes rules to assign values to other facts.

It assigns likelihood coefficients to the different facts to which it assigns a value. The likelihood coefficients are assigned by using the theory of possibilities. These coefficients can be likelihood functions.

All this is done in order to assist in the decision, that is to say, here, in the identification of the identified areas of interest and in the assignment of likelihood coefficients to these areas of interest.

In the system according to the invention, the expert system 10 uses basic knowledge comprising:

knowledge concerning the geographic environment of the aircraft to have an idea of the background on which the target is positioned: rock, snow, sand, grass, sea, road (possibly with knowledge concerning the swell: wave length and/or direction of propagation and/or wave height), and possibly relevant physical properties of the background which have an influence on its appearance in the images (such as, for example, the type of energy diffused, the reflectivity in the spectral bands of the different cameras),

knowledge concerning the characteristics of the aircraft (theoretical performance levels and/or current status of the aircraft and/or prediction of a future status),

knowledge concerning the technical characteristics of each of the cameras, comprising at least their respective spectral bands and possibly at least one of the following characteristics: their ranges depending on meteorological conditions, their resolution, their sensitivity to noises, their viewing angle, focal length, size and type of image sensors, accuracy, latency time, characteristics of the images supplied in real time (size, bit rate, information type, etc.), angular adjustments to the viewing axes,

knowledge concerning the meteorological conditions (which have an influence on the images supplied by the cameras such as, for example, the relative position of the sun, the humidity and temperature of the air, etc.),

possibly, knowledge concerning the onboard spotlights (their respective states: on or off and, possibly, their viewing axes, their emission power, their spectral bands, their theoretical ranges depending on the weather),

characteristics of the object sought (target or landing area).

When the object is a target sought during the mission, the characteristics of the target comprise a target type which is, for example, a shipwreck victim, a boat, a rock-climber. The knowledge concerning the object may also comprise the dimensions of the target, as well as, possibly, properties relevant to the target (of color, reflectivity type).

When the object is a landing area, the characteristics of the entity comprise, for example, conditions concerning its dimensions (for example, in the case of a helicopter, a square whose side length is at least equal to two times the diameter of the rotor of the helicopter), a condition concerning the hardness of the ground, a condition concerning the slope of the landing area.

The condition concerning the hardness of the ground is that it should be greater than a predetermined threshold.

The condition concerning the slope of the landing area is that it should be less than a predetermined threshold.

Advantageously, the storage module 15 is capable of storing, in different databases, the various basic items of knowledge. They also comprise databases of facts and rules specific to the two types of objects: target and landing area.

They also advantageously comprise:

an altimetric database storing information on the altimetry of the terrain according to the position of the carrier representing knowledge concerning the geographic environment of the aircraft,

and/or a geological database storing information on the geology of the terrain according to the position of the carrier, representing knowledge concerning the geographic environment of the aircraft.

The expert system 10 is capable of reading the knowledge in the storage module 15 and putting questions to the crew via the computer 9 to obtain basic knowledge.

For example, the expert system 10 can trigger the display, by the graphics module 9B, of predefined lists of types of target and/or of types of background and/or of values of different meteorological data, from which the crew can select parameters (type of target, type of background, value of different meteorological data) by means of the control module 8. The results of these selections constitute basic knowledge which is sent to the expert system 10 in the form of response from the computer 9 and/or which is stored in the storage module 15.

The knowledge concerning the geographic environment, concerning the meteorological conditions, concerning the technical characteristics of the cameras, concerning the spotlights, concerning the object sought, concerning the geographic environment, and concerning the aircraft, all has an influence on the quality of the output images of the different cameras (for example: range, disturbance by noise) and on the appearance of the object on the output images of the different cameras (for example: background/target contrast, presence of reflections).

For example, the range of the cameras depends on the visibility on the ground. The presence of reflections depends on the swell and on the presence or absence of sun. The reflections will be different depending on the angles (trim, roll, etc.) linked to the current attitude of the aircraft.

The expert system 10 is capable of deducing, from the basic knowledge and rules relating to said object (target or landing area), values of facts relating to the characteristics of the object on the images output from the cameras and on the quality of these images supplied by the cameras.

These deductions are not made directly, they are obtained by using an iterative reasoning. For example, the background on which the target is located may be known a priori but it may also be unknown at the outset and deduced by the expert system, by means of information rules concerning the geographic environment of the aircraft, such as, for example, the geographic limits of the search area and/or the minimum and maximum heights and/or altitudes for flying over the search area and/or road limits and/or a flight phase (take-off, cruising, etc.), and/or information on the altimetry of the terrain according to the position of the aircraft and/or information on the geology of the terrain according to the position of the aircraft and other basic knowledge.

For example, it is possible to deduce from the season, from the position of the aircraft and from the altimetry of the terrain, whether the background is snow or rock.

In another example, depending on the texture desired for the landing area and according to the knowledge of the background, the expert system, in order to deduce the characteristics of this landing area on an output image of a camera, first deduces relevant physical properties: diffused energy, reflectivity of UV light, etc.

Some rules are listed, by way of example, at the end of the description.

With the expert system assigning likelihood coefficients to each of the facts to which it assigns a value, it can assign likelihood coefficients to the areas of interest identified by the computation module 9A. A likelihood coefficient corresponds to a probability. It is a coefficient between 0 and 1. A likelihood coefficient assigned to an area of interest is a coefficient between 0 and 1 and corresponds to the probability that the predetermined object is actually located in the area of interest.

The likelihood coefficient assigned to an identified area of interest on an image corresponds to a likelihood coefficient assigned to a fact concerning the existence of an area of interest in an image supplied by a camera. The value of this fact is calculated by means of rules which check a compatibility and a consistency against other facts already deduced comprising facts relating to the quality of the images output from the cameras and the appearance of the object sought on an image output from the camera (for example, relating to the background/sought object contrast and/or the size of the object sought) and facts relating to the areas of interest identified by the first computation module 9A, as will be seen herein below (for example relating to the spots extracted from the images supplied by the camera, to the energy and/or the spectral bands of the spots identified on the images obtained from the camera).

An example of a rule which could be used to assign a likelihood coefficient to an area of interest (or spot) identified by the first computation module is given below:

If the fact “the camera i is operating correctly” and IF the fact “the background/target contrast is average to excellent” (given the known facts relating to the current meteorological conditions and to the characteristics of the camera) and IF the fact “there is a spot of minimum surface area extracted from the image supplied by the camera i” (given the known facts relating to the characteristics of the camera, to the 3D position and to the attitudes of the helicopter relative to the ground and to the theoretical dimensions of the target) and IF the fact “the energy and the spectral band associated with the extracted spot is compatible with certain laws of physics” (given the known facts relating to the current meteorological conditions, to the characteristics of the camera, to the characteristics of the background and of the target) and IF the fact “the likelihood coefficient computed from these facts is greater than a threshold” THEN the fact “existence of an area of interest in the image supplied by a camera i” presents a predetermined likelihood coefficient (for example greater than 0.7).

In the embodiment of the figures, the system according to the invention comprises the device 11 comprising the modules 12, 13, and the module 14 that makes it possible to supply to the expert system 10, in real time, knowledge concerning the meteorological conditions and concerning the current status of the carrier. This characteristic makes it possible to improve the effectiveness of the identification of the areas of interest by the expert system because it enables it to analyze a situation that is naturally variable (change of meteorology, position of the aircraft) in real time.

The expert system 10 can trigger different actions, to improve the quality of the images on which the identified areas of interest are identified and can take account thereof in the execution of the rules to assign values to facts (in fact, these actions have an influence on the values of the facts and rules). This characteristic makes it possible to facilitate the identification of the relevant identified areas of interest.

It is, for example, capable of controlling the switching-on and the switching-off of the spotlights 101, 102. To this end, the storage module 15 advantageously stores rules concerning the commands for switching on and switching off the search light based, for example, on the ambient brightness conditions.

When these spotlights are on, this modifies the quality of the output images of the cameras and/or the contrasts of a target relative to the background. The expert system 10 is capable of using the knowledge concerning the triggering of this action in the context of the execution of rules for assigning values to facts.

The expert system 10 is capable of triggering the implementation of methods by the computation module 9A.

The storage module 15 advantageously stores facts and rules enabling the expert system 10 to determine at least one image processing method and, possibly, image preprocessing method, to identify the areas of interest on the output images of the cameras 1, 2, 3. It is capable of triggering the execution of the processing/preprocessing methods chosen by the computation module 9A. This characteristic makes it possible to best adapt the image processing methods used to the search conditions and to the object sought (that is to say to the basic knowledge). This makes it possible to obtain better results than by implementing a predetermined processing or preprocessing method.

When the expert system determines that the contrast of the images supplied is a priori excellent, the strategy used is, for example (in the following order): grouping together of pixels which constitute straight lines, grouping together of pixels which constitute arcs, assembly of straight lines and arcs to constitute polygonal objects, computation of the perimeter, of the surface area and of the centre of gravity of these objects, computation of the position and of the form in 3D relative to the helicopter and finally comparison with the theoretical geometrical characteristics of the target.

By contrast, when the expert system determines that the contrast of the images supplied is average (for example, according to rule 9 hereinafter in the text), the strategy used is, for example, as follows: computing the average energy of the image, computing the energy associated with each pixel by means of statistical techniques of brightness intensity histogram type, detection of groupings of pixels corresponding to energy peaks by frequency bands, reconstruction of surfaces from these groupings, comparison with the theoretical characteristics of the background and of the target (frequencies emitted, energy reflectivity and absorption coefficients).

The expert system 10 is capable of receiving the results obtained during the implementation of these methods and of using them as knowledge in the context of the execution of the rules to assign values to facts. It receives, for example, the identified areas of interest ZI1 and deduces therefrom the associated likelihood coefficients, based on facts and rules.

The triggering of a preprocessing method (for example a filtering) makes it possible to obtain images of better quality than the output images of the cameras before identifying the identified areas of interest. The expert system is also capable of taking account, in the context of the execution, of rules for assigning values to facts. For example, the fact of having triggered the implementation of a particular preprocessing method may have an influence on the processing method used. The processing method used may also, in turn, have an influence on the values of the likelihood coefficients assigned to the areas of interest.

Advantageously, the computation module 9A uses, to implement the image processing method(s) to identify an identified area of interest on the output images of the cameras, an estimation of the size of a polygon which surrounds the object to be found on the output images of the cameras 1, 2, 3, that is to say in the two-dimensional image reference frame. This characteristic makes it possible to identify more easily an area of interest by eliminating the areas of greater size and makes it possible to limit the computation power used for the identification of the identified areas of interest.

This estimation is advantageously derived from a method implemented by the computation module 9A.

This method determines, in real time, that is to say at regular time intervals, from knowledge on the object sought (type of object and possibly geometrical characteristics of a parallelepiped which would encompass the object), from an estimation of the position of the aircraft, from an estimation of its trajectory and from the altimetry of the terrain, the dimensions, on the images concerned, of a parallelepiped which would encompass the target.

The estimation of the position of the aircraft and the estimation of its movement are advantageously performed from data obtained from the monitoring device 11 that makes it possible to monitor the current status of the aircraft. This step makes it possible to determine the number of pixels of offset that there are between two successive images supplied for each of the cameras.

The computation module 9A is capable of implementing at least one image processing method to identify areas of interest on the images obtained from cameras and possibly at least one image preprocessing method to facilitate the identification of the areas of interest. These methods are, for example, stored in a methods bank, not represented, in the first computer 9.

These methods are known to the person skilled in the art and are not detailed here. There are different types of preprocessing methods, such as, for example:

filters (one-dimensional or two-dimensional) that make it possible to attenuate the noises in images, such as, for example, a low-pass filter, a high-pass filter, a median filter, a wavelet filter,

image transformations that make it possible to perform frequency and/or time analyses, such as, for example, a Fourier transform, a fast Fourier transform, a Hadamard transform, an inverse transform, etc.,

methods for enhancing the contrasts between the background and the target,

pure geometrical analyses which make it possible to define useful areas of interest to be analyzed such as, for example:

translations and/or rotations and/or homothetic transformations in the three-dimensional reference frame of the Earth;

translations and/or rotations and/or homothetic transformations in the three-dimensional reference frame of the aircraft;

translations and/or rotations and/or homothetic transformations in the three-dimensional reference frame linked to the camera or in a two-dimensional reference frame linked to the image sensor of the camera,

global methods for restoring noise-affected images such as, for example, a method using a noise model, a least squares technique, the optimization of certain criteria under various types of constraints.

There are different types of image processing methods for identifying areas of interest on an image, such as, for example:

morphological analysis methods that make it possible to study forms: erosions, expansions,

segmentation methods for identifying certain types of objects such as, for example, a method for subdividing an image into rectangular regions, a method for recognizing straight lines, a method for recognizing curves,

grouping methods using moments,

correlation methods for identifying models of objects in an image relative to models predefined in a database (tree and/or graph comparison techniques).

The display module 9B is capable of presenting the identified areas of interest on the screens as can be seen in FIG. 3 and as explained previously.

The computation module 9A assigns them the same attributes as those which are assigned to the plotted areas of interest and stores them in the storage module 15.

As we have seen with reference to FIG. 3, the pilot is also capable of plotting 305 contours RT1, RT2, delimiting plotted areas of interest ZT1, ZT2 on the pilot images IP1, IP2 which are presented 304 to him in the pilot area 202 and which are obtained from output images captured 300 by the cameras 1, 2, 3.

A second computation module, for example the computation module 9A, is capable of assigning 306 them a likelihood coefficient. Advantageously, the likelihood coefficient which is assigned to them is predetermined. It is advantageously equal to 0.5. This value is particularly suitable because it corresponds to the probability that the visibility and flight conditions enable him to identify an object on the images which are presented to him using what he sees directly in his field of vision.

As a variant, the second computation module is the expert system 10. It deduces, for example, these likelihood coefficients from the base knowledge and possibly from knowledge concerning man's behavior when it comes to identifying areas of interest. This variant makes it possible to determine these first likelihood coefficients with greater accuracy.

Advantageously, the computation module 9A is capable of handling the tracking, in real time, of the plotted areas of interest ZT1, ZT2 on the images on which they are superimposed during the mission and the movement of the contours which delimit them on the display screens, by using techniques known to the person skilled in the art for tracking objects on the images. This is advantageously valid also for the identified ZI1 and relevant ZP1 areas of interest which will be described later. This characteristic enables the pilot to not lose sight of the targeted object (target or landing area) even at moments when greatly engaged with other issues (preparing for landing, for example).

The system according to the invention also comprises a third computation module 30, which could equally be the expert system 10 or the computation module 9A, to determine 307, from the positions and the likelihood coefficients of the plotted areas of interest ZT1, ZT2 on the pilot images IP1, IP2, IP3 and of the identified areas of interest ZI1 for an object on the output images of the cameras 1, 2, 3, a relevant area of interest IP1 corresponding to the area of interest, represented in FIG. 3, in which the object has the greatest chance of being located.

More specifically, the third computation module 30 determines a set of relevant areas of interest from a set of areas of interest comprising the plotted and/or identified areas of interest on a set of images.

In other words, the third computation module 30 is configured in such a way as to identify a set of relevant areas of interest from a set of areas of interest comprising each identified area of interest and each plotted area of interest on a set of images.

This third module is configured in such a way as to identify the set of relevant areas of interest from the positions and likelihood coefficients of each identified area of interest and of each plotted area of interest on a set of images, when the set of areas of interest comprises more than one area of interest. More specifically, the relevant areas of interest are defined from the distances separating said plotted and/or identified areas of interest.

Advantageously, the third computation module is configured in such a way that, when the set of areas of interest comprises a number of areas of interest, the set of relevant areas of interest comprises at least one area of interest.

The images included in the set of images are taken from the pilot images and the raw images (or output images of the camera or cameras).

The set of images can be predetermined and correspond to the set of output images and of pilot images. As a variant, the set of images is determined 307 by the crew.

The set of images advantageously comprises at least one pilot image and at least one raw image. It advantageously comprises the pilot images and the raw images from said at least one area of interest has been identified.

The control module 8 comprises means enabling the crew to select the set of images taken from the pilot images IP1, IP2, IP3 and the output images IS1, IS2, IS3 of the cameras which are transmitted to the expert system. To be more exact, the crew selects the output images of the cameras by selecting the expert images IE1, IE2, IE3 derived from these output images or the raw images. It may, for example, involve touch means.

The crew therefore selects only the images which seem to it to be of good quality or the images on which the identified areas of interest seem to it to be of good quality. This makes it possible to facilitate the identification of truly relevant areas of interest in which the target really has good chances of being located since the expert system eliminates the images which seem to it to be not relevant.

When there is no identified or plotted area of interest on this set of images, no relevant area of interest is identified. In other words, the third computation module is configured in such a way that, when the set of areas of interest does not comprise any area of interest, then no relevant area of interest is identified. The set of relevant areas of interest is null. When there is only one identified or plotted area of interest, a relevant area of interest corresponding to this area of interest is identified. In other words, the third computation module is configured in such a way that, when the set of areas of interest comprises a single area of interest, then a single relevant area of interest, corresponding to the identified or plotted area of interest on the set of images, is identified. It has the same position as the area of interest. The set of relevant areas of interest is null.

The third computation module 30 determines 309 the relevant area of interest by assigning 308 a correlation coefficient to the areas of interest. The correlation coefficient assigned to an area of interest is a function of the likelihood coefficient assigned to the area of interest concerned and of a distance representative of the distance separating the area of interest concerned from the other areas of interest.

For example, the correlation coefficient assigned to an area of interest is proportional to the likelihood coefficient assigned to this first area and inversely proportional to a distance representative of the distance separating this area of interest from the other areas of interest.

FIG. 5 shows, in a single two-dimensional image reference frame x, y, all the plotted ZT1, ZT2 and identified ZI1 areas of interest on the pilot images IP1, IP2, IP3 and on the output images of the cameras. The image reference frame is a unique reference frame in which the output images of the cameras are superimposed. Images which are superimposed should be understood to be images whose same pixels give images of one and the same scene.

The distance D representative of the distance separating the first plotted area of interest ZT1 from the other areas of interest in the two-dimensional image reference frame is represented.

In this example, this distance D is the distance separating the first plotted area of interest ZT1 from the closest area of interest, namely the second area of interest ZT2. In other words, it is the minimum distance separating the first plotted area of interest ZT1 from the other areas of interest.

As a variant, it could be the average distance separating the area of interest concerned from the other areas of interest.

The distance between two areas of interest is, in this example, the distance between the centers of gravity of the parallelepipeds delimiting the areas of interest concerned. This centre of gravity corresponds to the centre of the rectangle in the case where the parallelepiped is rectangular.

The relevant area of interest ZP1 represented in FIG. 3 is the area of interest to which is assigned the greatest correlation coefficient.

As a variant, the third computation module identifies one or more relevant areas of interest, such as, for example, all the first areas of interest or else only the areas of interest that have a correlation coefficient greater than a predetermined threshold.

The display module 9A is configured in such a way as to present 310, to the crew, on at least one screen 7A, 7B, the relevant area(s) of interest, when such exist.

The presentation consists advantageously, as can be seen in FIG. 3, in superimposing contours, delimiting the relevant areas of interest with an image called synthesis image IS derived from an output image of at least one camera 1, 2, 3.

Advantageously, when there are a number of relevant areas of interest, the manner in which they are presented depends on their respective correlation coefficients.

Advantageously, the color or the brightness of the rectangles delimiting the relevant areas of interest depends on their correlation coefficients.

Advantageously, the brightnesses of the rectangles delimiting the relevant areas of interest are proportional to their respective likelihood coefficients. As a variant, only the relevant area of interest that has the strongest correlation coefficient is represented differently from the other relevant areas of interest.

We have seen that one of the problems posed in a rescue mission is to identify a landing area.

The operation of the system according to the invention is identical in the case of the search for a landing area and in the case of the search for a target. Only the object sought changes. The facts and rules used by the expert system relating to these two types of objects are different. The storage module 15 advantageously stores these two types of facts and rules.

The system according to the invention can implement the steps of plotting, of identifying identified areas of interest and of determining relevant areas of interest to search for the target prior to these same steps for the search for the landing area.

Advantageously, the control module 8 comprises means enabling the crew to trigger the implementation of the steps of plotting, of identification of the identified areas of interest and of determination of the relevant areas of interest for one or other of the objects.

The display of the plotted and/or identified and/or relevant areas of interest relative to the landing area and to the target can be performed simultaneously or in succession. In the case of simultaneous display, the areas of interest relative to the landing area are advantageously represented differently from the areas of interest relative to the target.

The fact that the expert system uses knowledge concerning the geographic environment to have an idea of the background on which the landing area is sought and concerning the desired characteristics of the landing area (notably the desired texture and the dimensions) is fundamental to characterizing the landing area with certainty.

In practice, when the target is situated on a background of snow and/or ice type, it is important to know the degree of hardness of the texture and the size and the position of any holes before deciding to land there.

Now, even in a normal environment, in daytime with good visibility, it can be very difficult for the pilot to visually judge well the safety of these backgrounds in order to set down given the lighting conditions. At night, this can be impossible, even with the use of a high-power spotlight.

As can be seen in FIG. 3, the screen 7A comprises a textual display area 205 in which the display module can advantageously display textual information concerning, for example:

the target: for example, the correlation coefficient of the relevant area of interest and, possibly, information on the position of the target relative to the aircraft (for example the distance to the aircraft, the time to get there),

the landing area: the correlation coefficient of the relevant area and, possibly, information on its dimensions, its estimated slope and the hardness of the ground.

To this end, the system according to the invention advantageously comprises a computation module that makes it possible to compute the position of the target relative to the aircraft from the position in the image reference frame and from the dimensions of at least one relevant area of interest relative to the target.

The system also advantageously comprises a computation module that makes it possible to evaluate the properties of the landing area (slope; hardness of the ground; dimensions) from the characteristics of at least one relevant area of interest relative to the landing area. This is done by conventional image processing methods.

In the embodiment described in the patent application, the system comprises three cameras respectively operating in the ultra-violet radiation, the visible radiation and the infrared radiation. This characteristic makes it possible to increase the probability of identifying areas of interest in which the object is actually located since, depending on the type of mission and the meteorological conditions, the object will be more or less identifiable on one of these three spectral bands.

More generally, the system advantageously comprises at least one camera sensitive in the visible domain and outside the visible domain. For example, the system according to the invention may comprise a single camera sensitive in a visible, infrared or ultraviolet spectral band.

The system may also comprise at least one camera sensitive in the visible domain and one camera sensitive outside the visible domain.

This multi-spectral detection makes it possible to obtain more information than the pilot could obtain by the naked eye and thus increase the chances of detecting the object sought.

Advantageously, the expert system provided with learning capabilities enabling it to compute new facts and rules and to identify the identified areas of interest from information concerning the progress of the mission recorded during at least one past mission in the storage module 15. This characteristic makes it possible to enhance the performance levels of the expert system over time.

For this, the storage module 15 advantageously perform the archiving, in real time, of values, validities and dates associated with information, comprising at least: the images supplied by the cameras 1, 2, 3, during a mission, the trajectories of the carrier (position, speeds, altitudes, angles, etc.), the relevant events occurring (action of the pilot by means of the control module on the pilot and co-pilot screens, change of meteorology, failures, decisions taken by the expert system 10, the areas of interest identified (ZIi), plotted (ZTi) with i=1 to m, m=3 in FIG. 3, relevant (ZPi with i=1 to p, p=1 in FIG. 3).

The expert system offers a learning mode of operation outside of the missions during which it tries to find other facts and rules and, possibly, other processing/preprocessing methods from the information archived in the storage module 15 during one or more preceding missions.

Hereinafter in the text, a number of rule types that can be executed by the expert system are listed. They represent the reasoning performed by an expert. They are called one after the other in order to create reasoning sequences. All these reasoning can be represented in the form of rules of the type “IF condition true THEN execute action”. This representation may vary depending on the context of the application, the formal logic used (propositional logic, predicate logic, etc.). These rules are applied to facts to which values have been assigned to assign values to other facts and/or to trigger actions (questions put to the first computer 9A which transmits the responses to the expert system 10 and triggering of the implementation of methods by the first computer 9A and recovery of the results, switching on of a spotlight). In the interests of clarity, the behavior of the expert system is explained in plain language. The rules are given as a nonlimiting example.

Rules that make it possible to assign a value to the background type fact and to other characteristics of the background based on the mission type:

### RULE 1:

IF (the target is of shipwreck victim in water type) THEN (the wave emission surface area is less than 1 m2) and (the background is of water type)

### LIKELIHOOD=1

### RULE 2:

IF (the mission is of rock-climber on vertical wall type) THEN (the wave emission surface area is greater than 2 m2) and (the background is of rock type)

### LIKELIHOOD=0.5

### RULE 3:

IF (the mission is of rock-climber on vertical wall type) THEN (the wave emission surface area is greater than 2 m2) (the background is of snow type)

### LIKELIHOOD 0.3

Rules that make it possible to obtain values on precise information concerning the background:

### RULE 4:

IF (the height of the waves is greater than 3 m) THEN (the sea is rough)

### LIKELIHOOD=1

### RULE 5:

IF (the wave length of the swell is greater than 50 m) THEN (the swell is long)

### LIKELIHOOD=1

### RULE 6:

IF (the sea is rough) AND IF (the swell is long) AND IF (the sun is low) THEN (strong presence of reflections) LIKELIHOOD=0.8

Rules that make it possible to assign values to facts relating to the quality of the images obtained from the cameras

### RULE 7:

IF (the humidity of the atmosphere is less than 30%) AND IF (the atmospheric pressure is greater than 1020 hPA) THEN (the VISIBLE camera is little disturbed by noise) and (the IR camera is little disturbed by noise) LIKELIHOOD=0.9

### RULE 8:

IF (the background is snow) AND IF (the sun is out) AND IF (the lighting incidence is greater than 60°) THEN (on the UV camera the background/target contrast is excellent) and (on the IR camera the background/target contrast is excellent) and (on the VISIBLE camera the background/target contrast is average) LIKELIHOOD=0.7

### RULE 9:

IF (the background is snow) AND IF (the sun is not out) AND IF (the UV spotlight is on) AND IF (the lighting incidence is greater than 60°) AND IF (the distance from the helicopter to the background is greater than 500 m) THEN (on the UV camera the background/target contrast is poor) AND (on the IR camera the background/target contrast is excellent) AND (on the VISIBLE camera the background/target contrast is average) LIKELIHOOD=0.7

### RULE 10:

IF (the background is snow) AND IF (the sun is not out) AND IF (the UV spotlight is on) AND IF (the lighting incidence is less than 30°) AND IF (the distance from the helicopter to the background is less than 30 m) THEN (on the UV camera the detection of particles is possible) AND (on the IR camera nothing can be done) AND (on the VISIBLE camera the roughness of the background can be computed) LIKELIHOOD=0.6

Rule making it possible to determine an image processing method:

IF (the VISIBLE camera is operating) AND IF (the background is of snow type) AND IF (the background/target contrast is excellent) AND IF (the VISIBLE camera is little disturbed by noise) THEN (the search strategy is SEGMENTATION_THRESHOLDING) LIKELIHOOD=1

Rule making it possible to eliminate cameras for the identification of areas of interest:

IF (the UV camera is operating) AND IF (the background/target contrast is poor) THEN (do not use it for a search) ACTION: erase expert system image visible in the graphic area 203 LIKELIHOOD=1

Rule making it possible to launch an image processing method:

IF (the VISIBLE camera is operating) AND IF (the search strategy is SEGMENTATION_THRESHOLDING) THEN ACTION: launch computation “C1” with parameters “P1”, “P2”; ACTION: launch computation “C2” with parameters “P1”, “P2”.
The first computer 9A sends the results of its computations which correspond to the position and the size of the identified areas of interest. The expert system 10 assigns them a likelihood coefficient.

The system according to the invention, based both on the crew and on an expert system, enables the crew to identify predetermined objects (target or landing area) with certainty. It represents an enhanced solution whether compared to the solutions of the prior art which were based only on the crew or compared to a solution which would be based only on an expert system. In practice, when the visibility conditions are such that the crew cannot identify areas of interest, the system according to the invention draws its attention to areas of interest derived from the expert system and vice versa when the crew perfectly identifies the object by the naked eye.

The system does not increase the workload of the crew, which makes it possible not to degrade the flight safety conditions. In practice, all the basic knowledge used by the expert system can be supplied either by automatic means 11, 14 or else before the flight, by the crew. The expert system needs no intervention from the crew during the flight to identify areas of interest.

The fact that the identification of the areas of interest is performed in real time is compatible with the proposed mission type.

1. A system for aiding in the rescue of a target by aircraft, comprising, installed in the aircraft:
at least one camera capable of supplying images, being output images of said camera, of a scene of the environment of the aircraft,
a display module making it possible to present, to the crew, images, being pilot images, corresponding to output images of said at least one camera which have undergone modifications enabling the crew to view them correctly, on at least one screen,
a control module enabling the crew to plot at least one contour delimiting an area of interest, being a plotted area of interest, on the pilot images which are presented to it,
a first computation module configured to identify, on output images of said at least one camera, at least one area of interest, being an identified area of interest, in which a predetermined object is likely to be located,
an expert system making it possible to assign a likelihood coefficient to said at least one identified area of interest,
a second computation module configured to assign a likelihood coefficient to said at least one plotted area of interest, and
a third computation module making it possible to identify a set of relevant areas of interest from a set of areas of interest comprising each identified area of interest and each plotted area of interest on a set of images,
the third computation module being configured in such a way as to identify a set of relevant areas of interest from the positions and likelihood coefficients of each identified area of interest and of each plotted area of interest on said set of images when the set of areas of interest comprises more than one area of interest,
the third computation module also being configured in such a way that:
when the set of areas of interest does not comprise any area of interest, no relevant area of interest is identified, and
when the set of areas of interest comprises a single area of interest, a single relevant area of interest, corresponding to said area of interest, is identified,
the display module being configured in such a way as to present to the crew said at least one relevant area of interest, when it exists, on at least one screen.

2. The rescue aid system according to claim 1, in which the expert system is configured in such a way as to use basic knowledge comprising knowledge concerning the geographic environment of the aircraft, concerning the meteorological conditions, concerning said object, concerning the technical characteristics of said at least one camera, concerning characteristics of the aircraft, to deduce therefrom, by the use of rules, values of facts relating to the characteristics of the object on the output images of said at least one camera and on the quality of the images obtained from said at least one camera.

3. The rescue aid system according to claim 1, in which the expert system is capable of triggering actions to improve the quality of the images on which the first computation means identify the identified areas of interest, the expert system being capable of taking account thereof in the context of the execution of rules to assign values to facts.

4. The rescue aid system according to claim 3, in which the expert system is capable of triggering the switching on and/or the switching off of at least one spotlight capable of emitting a visible light and possibly an ultra-violet light, in the field of view of said at least one camera and/or of determining at least one method for preprocessing the output images of said at least one camera and of triggering the execution of said at least one method by the computation module.

5. The rescue aid system according to claim 1, in which the expert system is capable of determining at least one processing method for identifying identified areas of interest on the output images of said at least one camera and of triggering the execution of said at least one method by the computation module.

6. The rescue aid system according to claim 1, in which the first computation module is configured to identify an identified area of interest in which an object corresponding to a target to be rescued is likely to be located.

7. The rescue aid system according to claim 1, in which the first computation module (9A) is configured to identify an identified area of interest in which an object corresponding to an aircraft landing area is likely to be located.

8. The rescue aid system according to claim 1, in which the characteristics of the landing area comprise a condition concerning its dimensions, a condition concerning its slope and a condition concerning the hardness of the ground.

9. The system according to claim 1, comprising a monitoring device making it possible to deliver, in real time to the expert system, knowledge concerning the current status of the aircraft and a meteorological module making it possible to deliver, in real time to the expert system, knowledge concerning the meteorological conditions.

10. The system according to claim 1, in which the display module is configured to present to the crew each identified area of interest.

11. The system according to claim 1, in which the representations of the areas of interest are polygons delimiting said areas of interest.

12. The system according to claim 1, in which the control module enables the crew to select expert images and copy them into a display area dedicated to the display of the pilot images.

13. The system according to claim 1, in which the likelihood coefficient assigned to the plotted areas of interest is equal to 0.5.

14. The system according to claim 1, in which the control module enables the crew to select the set of images.

15. The system according to claim 1, in which, when the set of areas of interest comprises a number of areas of interest, the third computation module determines said at least one relevant area of interest by assigning, to the areas of interest of said set, a correlation coefficient, the correlation coefficient assigned to an area of interest being a function of said likelihood coefficient assigned to the area of interest concerned and of a distance separating the area of interest concerned from the other areas of interest of the set of areas of interest.

16. The system according to claim 1, in which the third computation module is configured to determine, when there is at least one plotted or identified area of interest in the set of images, a single relevant area of interest corresponding to the area of interest that has the highest correlation coefficient.

17. The system according to claim 1, in which the relevant areas of interest correspond to the areas of interest that have a correlation coefficient greater than a predetermined threshold.

18. The system according to claim 1, in which, when the third computation module determines a number of relevant areas of interest, the display module gives different representations of the relevant areas of interest which have different correlation coefficients.

19. The system according to claim 1, comprising at least one camera sensitive in the visible domain and outside the visible domain and/or at least one camera sensitive in the visible domain and one camera sensitive outside the visible domain.

20. The system according to claim 1, comprising three cameras operating respectively in ultra-violet radiation, visible radiation and infrared radiation.
